(19) United States
(12) Patent Application Publication
(10) Pub. No.: US 2011/0047819 A1
(43) Pub. Date: Mar. 3, 2011

(54) SOFT, SHOCK-DAMPING THERMOPLASTIC ELASTOMERS

(75) Inventor: Marcel Pelletier, Valleyfield (CA)

(73) Assignee: POLYONE CORPORATION, Avon Lake, OH (US)

(21) Appl. No.: 12/674,549

(22) PCT Filed: Aug. 27, 2008
(86) PCT No.: PCT/US08/74394

§ 371 Date: Feb. 22, 2010

Related U.S. Application Data
(60) Provisional application No. 60/970,402, filed on Sep. 6, 2007.

(51) Int. Cl. A43B 13/38; F16J 15/00; B29C 67/00; C08L 25/06; C08J 9/00; C08K 3/22

(52) U.S. Cl. 36/43; 277/590; 264/239; 524/525; 521/139; 524/413

(57) ABSTRACT

A system of two different styrenic thermoplastic elastomers is disclosed. One styrenic thermoplastic elastomer is vinyl-isoprene styrene-isoprene-styrene which is known for its shock-damping properties. The other styrenic thermoplastic elastomer is oil absorbing and known for softness on the Shore A hardness scale. The system includes plasticizer oil. The system can be molded into articles that can provide dissipation of impact energy, for shock absorbing elastomeric uses, such as seals, closures, shoe insoles, and other goods.

### CLAIM OF PRIORITY

This application claims priority from U.S. Provisional Patent Application Ser. No. 60/970,402 bearing Attorney Docket Number 12007015 and filed on Sep. 6, 2007, which is incorporated by reference.

### FIELD OF THE INVENTION

This invention relates to soft thermoplastic elastomers that have good shock-damping or impact energy dissipation properties.

### BACKGROUND OF THE INVENTION

The world of polymers has progressed rapidly to transform material science from wood and metals of the 19^{th} Century to the use of thermoset polymers of the mid-20^{th} Century to the use of thermoplastic polymers of later 20^{th} Century.

Thermoplastic elastomers (TPEs) combine the benefits of elastomeric properties of thermoset polymers, such as vulcanized rubber, with the processing properties of thermoplastic polymers. Therefore, TPEs are preferred because they can be made into articles using injection molding, extrusion and blow-molding equipment.

### SUMMARY OF THE INVENTION

What the art needs is a new formulation of soft thermoplastic elastomer (TPE) that has good impact energy dissipation characteristics, which is beneficial for providing plastic articles with the property of good shock-damping.

“Damping” refers to the dissipation of vibrational energy.

“Shock-damping” refers to the absorption or dissipation of impact energy through a system, with minimum impact resilience or rebound.

The present invention solves that industry need by using a TPE formulation that utilizes a combination of two different styrene-based thermoplastic elastomer compounds (known also by the acronym TPE-S) to provide a plastic article with good shock-damping.

One aspect of the invention is a thermoplastic elastomer shock-damping system, comprising two different styrene-based thermoplastic elastomer compounds and plasticizer oil, wherein one compound is a vinyl-isoprene styrene-based thermoplastic elastomer, and the other compound is not.

The system can have a Shore A hardness of less than about 50 Shore A and preferably less than about 30 Shore A.

Optionally, the system can be cured into a thermoplastic vulcanizate.

Optionally, the system can be foamed.

Features of the invention will become apparent with reference to the following embodiments.

### EMBODIMENTS OF THE INVENTION

Vinyl-Isoprene TPE-S

U.S. Pat. No. 4,987,914 (Maeda et al.) discloses what is meant by vinyl-isoprene styrene-based thermoplastic elastomer compound and therefore is incorporated by reference herein.

As reported by Maeda et al., this specific type of TPE-S is characterized by a composition comprising a block copolymer which has a numerical average molecular weight of 30,000 to 300,000 and is composed of two or more blocks consisting of aromatic vinyl units having a numerical average molecular weight of 2500 to 40,000, and one or more blocks containing a vinyl bonding content of not less than 40%, having a peak temperature of primary dispersion of tan δ of at least 0° C., and consisting of isoprene or isoprene-butadiene units in which at least a part of carbon-carbon double bonds may be hydrogenated.

More specifically, vinyl-isoprene TPE-S useful in this invention (“viTPE-S” for these purposes) is a block copolymer having a number average molecular weight of 30,000 to 300,000 composed of at least two blocks consisting of aromatic vinyl units each having a number average molecular weight of 2,500 to 40,000 and at least one block containing a vinyl bond content of not less than 40%, having a peak temperature of primary dispersion of tan δ of at least 0° C., and consisting of isoprene or isoprene-butadiene units in which at least a portion of the carbon-carbon double bonds may be hydrogenated.

viTPE-S is well known as a damping material and has the physical strength equivalent to that of vulcanized rubber. As explained in Maeda et al., viTPE-S has excellent vibration absorption and vibration damping properties.

viTPE-S is commercially available from Septon America in a variety of hydrogenated and non-hydrogenated grades marketed under the brand “Hybrar”. Non-hydrogenated grades are preferred because they have higher glass transition temperatures than hydrogenated grades and because they have a higher peak temperature of tan δ than do hydrogenated grades. Indeed, grade 5127 has a Tg of 8° C. and a Peak Temp. of tan δ of 20° C. For further information, one can consult http://www.septon.info/en/hybrar/what_hybrar.html.

Unfortunately, certain non-hydrogenated grades of viTPE-S are hard materials, approximately 60-90 on the Shore A scale. More unfortunately, viTPE-S is not friendly to oil and other emollients often used to fill and soften thermoplastic and thermoset polymers. Therefore, while non-hydrogenated viTPE-S is capable of excellent vibration absorption and shock-damping, it is not soft and can not be made soft.

Second TPE-S

The second TPE-S contributes oleophilic properties to the thermoplastic elastomer system. Any TPE-S that is softer in Durometer Shore A hardness and more oil absorbing than viTPE-S is a candidate to be the second TPE-S of the system. For distinguishing purposes, this oil absorbing TPE-S will bear the acronym “oaTPE-S”.

Non-limiting examples of oaTPE-S compounds include styrenic block copolymers of styrene hard blocks on either side of a middle, softer block. The softer block can butadiene (styrene-butadiene-styrene or SBS), ethylene/butylene (styrene-ethylene/butylene-styrene or SEBS), ethylene/propylene (styrene-ethylene/propylene-styrene or SEPS), isoprene (styrene-isoprene-styrene or SIS), Isobutylene (styrene-isobutylene-styrene or SIBS), etc., and combinations thereof. Any of these TPE-S compounds are oil absorbing and often mixed with paraffinic oil or other emollients to reduce Shore A scale hardness.

Commercially available oaTPE-S compounds are well known to those skilled in the art. Global suppliers such as Kraton Company of Houston Tex. and Kaneka of Japan make and sell a variety of grades of oaTPE-S compounds.

Plasticizer Oil

As mentioned above, paraffinic oil, also known as mineral oil, is often used to soften and fill thermoplastics, thermosets, and TPE-S which has both thermoplastic and elastomeric components. Other oils and emollients can also be used so long as they are not incompatible with the viTPE-S or the oaTPE-S.

Optional Additives

The system of two different TPE-S compounds can include conventional plastics additives in an amount that is sufficient to obtain a desired processing or performance property for the compound. The amount should not be wasteful of the additive nor detrimental to the processing or performance of the compound. Those skilled in the art of thermoplastics compounding, without undue experimentation but with reference to such treatises as Plastics Additives Database (2004) from Plastics Design Library (www.williamandrew.com), can select from many different types of additives for inclusion into the compounds of the present invention.

Non-limiting examples of optional additives include adhesion promoters; biocides (antibacterials, fungicides, and mildewcides), anti-fogging agents; anti-static agents; bonding, blowing and foaming agents; curing agents; dispersants; fillers and extenders; fire and flame retardants and smoke suppressants; impact modifiers; initiators; lubricants; micas; pigments, colorants and dyes; oils and plasticizers; processing aids; release agents; silanes, titanates and zirconates; slip and anti-blocking agents; stabilizers; stearates; ultraviolet light absorbers; viscosity regulators; waxes; and combinations of them.

Table 1 shows the acceptable and desirable ranges of ingredients for the thermoplastic elastomer system of the present invention. All but the two types of TPE-S and oil are optional for the present invention.

TABLE 1
Ranges of Ingredients

| Ingredient | | |
|---|---|---|
| (Wt. Percent) | Acceptable | Desirable |
| viTPE-S | 10-50 | 20-40 |
| oaTPE-S | 10-50 | 15-35 |
| Plasticizer Oil | 10-50 | 20-40 |
| Wax | 0-2% | 0.1-0.5% |
| Anti-oxidant | 0-4% | 0.05-0.2% |
| Dusting Agent | 0-1% | 0-0.5% |
| Other Optional | 0-10% | 0-5% |
| Additives | | |

Processing

The preparation of compounds of the present invention is uncomplicated. The compound of the present can be made in batch or continuous operations.

Mixing in a continuous process typically occurs in an extruder that is elevated to a temperature that is sufficient to melt the polymer matrix (approximately 115° C.-200° C.) with addition either at the head of the extruder or downstream in the extruder of the solid ingredient additives. Plasticizer oil can be pre-mixed with the oaTPE-S in a ribbon blender or optionally added downstream by side feeding into the barrel. Extruder speeds can range from about 50 to about 500 revolutions per minute (rpm), and preferably from about 100 to about 300 rpm. Typically, the output from the extruder is pelletized for later extrusion or molding into polymeric articles.

Mixing in a batch process typically occurs in a Banbury-type mixer that is also elevated to a temperature that is sufficient to melt the polymer matrix to permit addition of the solid ingredient additives. The mixing speeds range from 60 to 1000 rpm. Also, the output from the mixer is chopped into smaller sizes for later extrusion or molding into polymeric articles.

Subsequent extrusion or molding techniques are well known to those skilled in the art of thermoplastics polymer engineering. Without undue experimentation but with such references as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (www.williamandrew.com), one can make articles of any conceivable shape and appearance using compounds of the present invention.

### Usefulness of the Invention

TPE-S of the present invention, based on the combination of viTPE-S and oaTPE-S and oil provides shock-damping. As such, and with the advantage of being capable of being injection molded or extruded, soft plastic articles needing impact energy dissipation features can be made from formulations of the present invention for such uses as seals, closures, shoe insoles, and other articles previously made from foamed plastics, soft rubber, etc. A system of the present invention, when used as a shoe insole, can provide cushioned shock absorption with minimal rebound.

Table 2 shows an example of the present invention.

TABLE 2
Formulation (Wt. %)

| Ingredient/Commercial Source | Purpose | 1 |
|---|---|---|
| Hybrar 5127 TPE (Septon America, | viTPE-S Matrix | 27.3 |
| Pasadena, TX) (84 Shore A) | | |
| Kraton G1641H SEBS (Kraton, Houston, | oaTPE-S Matrix | 22.2 |
| TX) | | |
| Hydrobrite 550 PO Mineral Oil | Softener Oil | 49.5 |
| (Sonneborn, Tarrytown, NY) | | |
| Kemamide E Ultra Erucamide wax | Mold Release | 0.3 |
| (Chemtura, Middlebury, CT) | Agent | |
| Irganox 1010 Phenolic Antioxidant (Ciba, | Anti-oxidant/UV | 0.1 |
| Tarrytown, NY) | Package | |
| Weston TNPP Phosphite Anti-oxidant | Anti-oxidant | 0.3 |
| (Chemtura) | | |
| Microthene 709FA High Density | Dusting Agent | 0.3 |
| Polyethylene (Equistar, Houston, TX) | | |

The example was made using a Werner-Pflederer twin-screw extruder set at 115° C. in zone 1; 65-188° C. in zones 2-6; with a die temperature at 200° C. The extruder rotated at 250 rpm. All ingredients were added at Zone 1, except that 30 wt. % oil (60% of the oil amount) was pre-mixed into the oaTPE-S matrix using a high intensity mixer, and the remainder of the oil was added at the injection port on the side of the barrel. The melt-mixed compound was pelletized for further handling.

Pellets of all Examples were molded into tensile test bars using a Van Dorn injection molding machine, operating at 200° C. temperature.

Table 3 shows experimental results of physical properties.

TABLE 3
Test Results

| Test | ASTM | 1 |
|---|---|---|
| Melt Flow Index (g/10 min.) 190° C. and | D1238 | 97 |
| 2.16 kg | | |
| Ultimate Tensile Strength (psi) parallel to | D412 | 392 |
| flow | | |
| Ultimate Tensile Strength (psi) | D412 | 384 |
| perpendicular to flow | | |
| Elongation at Break (%) parallel to flow | D412 | 977% |
| Elongation at Break (%) perpendicular to | D412 | 980% |
| flow | | |
| 50% Modulus (psi) parallel to flow | D412 | 24 |
| 50% Modulus (psi) perpendicular to flow | D412 | 24 |
| 100% Modulus (psi) parallel to flow | D412 | 29 |
| 100% Modulus (psi) perpendicular to flow | D412 | 27 |
| 200% Modulus (psi) parallel to flow | D412 | 40 |
| 200% Modulus (psi) perpendicular to flow | D412 | 39 |
| 300% Modulus (psi) parallel to flow | D412 | 58 |
| 300% Modulus (psi) perpendicular to flow | D412 | 55 |
| Tear Resistance (pli) parallel to flow | D624 | 37 |
| Tear Resistance (pli) perpendicular to flow | D624 | 42 |
| Specific Gravity | D792 | 0.89 |
| Shore A Hardness (10 sec. dwell) | D2240 | 6 |
| Compression Set (%) at 23° C. | D395 | 14% |

The example exhibited a dramatically reduced hardness (6 Shore A in penultimate row of Table 3) compared with a Shore A hardness of the viTPE-S alone (84 Shore A).

The invention is not limited to the above embodiments. The claims follow.

What is claimed is:

1. A thermoplastic elastomer shock-damping system, comprising
(a) two different styrene-based thermoplastic elastomer compounds and
(b) plasticizer oil,
wherein one compound is a vinyl-isoprene styrene-based thermoplastic elastomer compound and the other compound is not.

2. The system of claim 1, wherein the vinyl-isoprene styrene-based thermoplastic elastomer compound comprises a block copolymer having a number average molecular weight of 30,000 to 300,000 composed of at least two blocks consisting of aromatic vinyl units each having a number average molecular weight of 2,500 to 40,000 and at least one block containing a vinyl bond content of not less than 40%, having a peak temperature of primary dispersion of tan d of at least 0° C., and consisting of isoprene or isoprene-butadiene units in which at least a portion of the carbon-carbon double bonds may be hydrogenated.

3. The system of claim 1, wherein the other compound is a styrenic block copolymer selected from the group consisting of styrene-butadiene-styrene, styrene-ethylene/butylene-styrene, styrene-ethylene/propylene-styrene, styrene-isoprene-styrene, styrene-isobutylene-styrene, and combinations thereof.

4. The system of claim 1, further comprising additives selected from the group consisting of adhesion promoters; biocides; anti-fogging agents; anti-static agents; bonding, blowing and foaming agents; dispersants; curing agents; fillers and extenders; fire and flame retardants and smoke suppressants; impact modifiers; initiators; lubricants; micas; pigments, colorants and dyes; processing aids; release agents; silanes, titanates and zirconates; slip and anti-blocking agents; stabilizers; stearates; ultraviolet light absorbers; viscosity regulators; waxes; and combinations of them.

5. The system of claim 1, wherein the vinyl-isoprene styrene-based thermoplastic elastomer compound comprises from about 10 to about 50 weight percent of the system, wherein the other styrene-based thermoplastic elastomer compound comprises from about 10 to about 50 weight percent of the system, and wherein the plasticizer oil comprises from about 10 to about 50 weight percent of the system.

6. The system of claim 1, wherein the hardness of the system is less than about 50 Shore A.

7. A molded article, comprising a system of claim 1.

8. The article of claim 7, wherein the article is shaped as a shoe insole.

9. The article of claim 7, wherein the article is shaped as a seal or closure.

10. A method of using the system of claim 1, comprising the step of molding the system into an article that absorbs impact energy or damps impact energy.

11. The system of claim 2, wherein the other compound is a styrenic block copolymer selected from the group consisting of styrene-butadiene-styrene, styrene-ethylene/butylene-styrene, styrene-ethylene/propylene-styrene, styrene-isoprene-styrene, styrene-isobutylene-styrene, and combinations thereof.

12. The system of claim 2, further comprising additives selected from the group consisting of adhesion promoters; biocides; anti-fogging agents; anti-static agents; bonding, blowing and foaming agents; dispersants; curing agents; fillers and extenders; fire and flame retardants and smoke suppressants; impact modifiers; initiators; lubricants; micas; pigments, colorants and dyes; processing aids; release agents; silanes, titanates and zirconates; slip and anti-blocking agents; stabilizers; stearates; ultraviolet light absorbers; viscosity regulators; waxes; and combinations of them.

13. The system of claim 2, wherein the vinyl-isoprene styrene-based thermoplastic elastomer compound comprises from about 10 to about 50 weight percent of the system, wherein the other styrene-based thermoplastic elastomer compound comprises from about 10 to about 50 weight percent of the system, and wherein the plasticizer oil comprises from about 10 to about 50 weight percent of the system.

14. The system of claim 2, wherein the hardness of the system is less than about 50 Shore A.

15. The system of claim 3, further comprising additives selected from the group consisting of adhesion promoters; biocides; anti-fogging agents; anti-static agents; bonding, blowing and foaming agents; dispersants; curing agents; fillers and extenders; fire and flame retardants and smoke suppressants; impact modifiers; initiators; lubricants; micas; pigments, colorants and dyes; processing aids; release agents; silanes, titanates and zirconates; slip and anti-blocking agents; stabilizers; stearates; ultraviolet light absorbers; viscosity regulators; waxes; and combinations of them.

16. The system of claim 3, wherein the vinyl-isoprene styrene-based thermoplastic elastomer compound comprises from about 10 to about 50 weight percent of the system, wherein the other styrene-based thermoplastic elastomer compound comprises from about 10 to about 50 weight percent of the system, and wherein the plasticizer oil comprises from about 10 to about 50 weight percent of the system.

17. The system of claim 3, wherein the hardness of the system is less than about 50 Shore A.

18. The system of claim 4, wherein the vinyl-isoprene styrene-based thermoplastic elastomer compound comprises from about 10 to about 50 weight percent of the system, wherein the other styrene-based thermoplastic elastomer compound comprises from about 10 to about 50 weight percent of the system, and wherein the plasticizer oil comprises from about 10 to about 50 weight percent of the system.

19. The system of claim 4, wherein the hardness of the system is less than about 50 Shore A.

20. The system of claim 5, wherein the hardness of the system is less than about 50 Shore A.
